(19) United States
(12) Patent Application Publication
(10) Pub. No.: US 2026/0208850 A1
(43) Pub. Date: Jul. 23, 2026

(54) RECONFIGURABLE AIRCRAFT WINGS

(71) Applicant: OnwardAir, Inc., Houston, TX (US)

(72) Inventors: Scott Edward Parazynski, Houston, TX (US); Michael Richard Teeter, Cypress, TX (US); Keven Dale Coates, Cypress, TX (US)

(21) Appl. No.: 19/452,494

(22) Filed: Jan. 19, 2026

Related U.S. Application Data
(60) Provisional application No. 63/746,441, filed on Jan. 17, 2025.

(51) Int. Cl. B64C 3/56; B64C 29/00

(52) U.S. Cl. CPC B64C 3/56; B64C 29/0025

(57) ABSTRACT

An aircraft includes a reconfigurable wing including a fixed wing portion fixedly coupled with and extending laterally from a fuselage and an adjustable wing portion extending from and adjustably coupled with the fixed wing portion by a hinge mechanism including a bearing including a first bearing member coupled with the fixed wing portion and a second bearing member rotatably coupled with the first bearing member and fixedly coupled with the shaft at an interface between a plurality of bearing member flat sections of the second bearing member and a plurality of shaft flat sections of the shaft. A drive assembly including an electric machine is operatively coupled with and configured to drive the shaft of the hinge mechanism to adjust positioning of the adjustable wing portion relative to the fuselage.

### CROSS-REFERENCE

The present application claims priority to and the benefit of U.S. application No. 63/746,441 filed Jan. 17, 2025, and the same is hereby incorporated by reference.

### BACKGROUND

The present application relates to reconfigurable aircraft wings including reconfigurable aircraft wings that are adjustable under both static (at rest) and in flight modes of aircraft operation and to related apparatuses, systems, and processes including actuators, drives, and hinges suitable for reconfigurable aircraft wings as well as for other reconfigurable aircraft structures.

A number of proposals have been made to provide reconfigurable aircraft wings and related apparatuses, systems, and processes. Existing proposals suffer from a number of disadvantages, shortcomings, and unmet needs including those respecting, complexity, durability, efficacy, efficiency, and reliability, among others. There remains a significant need for the unique apparatuses, processes, and systems disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include apparatuses including reconfigurable aircraft wings. Some embodiments include unique processes including reconfigurable aircraft wings. Some embodiments include unique systems including reconfigurable aircraft wings. Further embodiments, forms, objects, features, advantages, aspects, and benefits shall become apparent from the following description and drawings.

### BRIEF DESCRIPTION OF THE DRAWINGS

FIGS. 1-4 are perspective views depicting certain aspects of an example aircraft in several different configurations.

FIG. 5 is a perspective view depicting certain aspects of a reconfigurable wing of the aircraft of FIGS. 1-4 in an example configuration.

FIG. 6 is a perspective view depicting certain aspects of a reconfigurable wing of the aircraft of FIGS. 1-4 in another example configuration.

FIG. 7 is a detail, partially transparent view depicting certain aspects of a reconfigurable wing of the aircraft of FIGS. 1-4.

FIG. 8 is a detail, partially transparent view depicting certain aspects of a reconfigurable wing of the aircraft of FIGS. 1-4.

FIG. 9 is a detail, partially transparent view depicting certain aspects of a reconfigurable wing of the aircraft of FIGS. 1-4.

FIG. 10 is a detail, partially transparent view depicting certain aspects of a reconfigurable wing of the aircraft of FIGS. 1-4.

FIG. 11 is a detail, partially transparent view depicting certain aspects of a reconfigurable wing of the aircraft of FIGS. 1-4.

FIG. 12 is schematic view of depicting certain aspects of a reconfigurable wing of the aircraft of FIGS. 1-4.

FIG. 13 is an axial sectional view of depicting certain aspects of an example harmonic drive of the aircraft of FIGS. 1 and 2.

FIG. 14 is a radial sectional view of depicting certain aspects of the example harmonic drive of FIG. 13.

FIG. 15 is a schematic view depicting certain aspects of another example reconfigurable aircraft wing in an example configuration.

FIG. 16 is a schematic view depicting certain aspects of the example reconfigurable aircraft wing of FIG. 15 in another example configuration.

FIGS. 17 and 18 are schematic views depicting certain aspects of hinge mechanisms according to the present disclosure.

### DETAILED DESCRIPTION OF EXAMPLE EMBODIMENTS

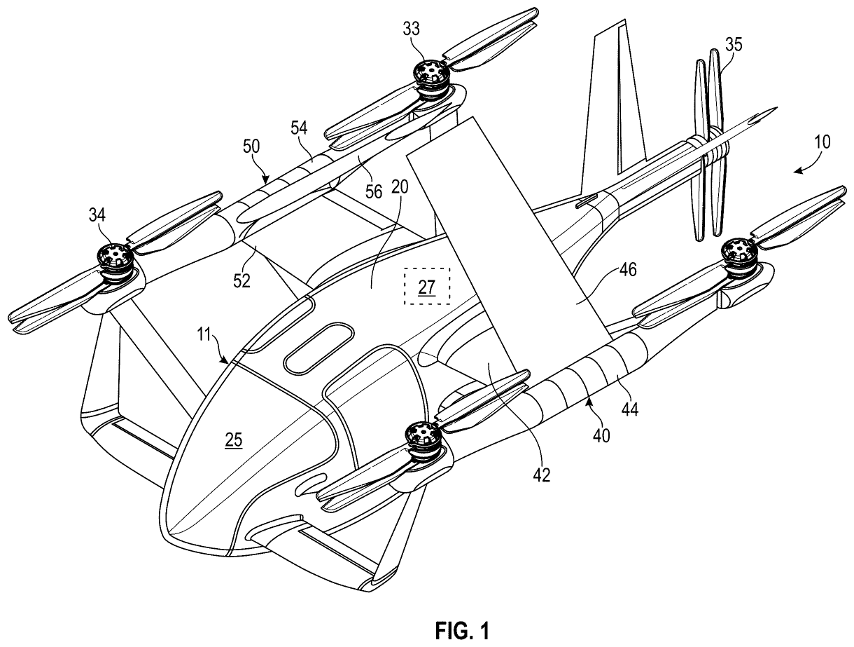

Referring now to the figures with initial reference to FIGS. 1-4, there is illustrated an example aircraft 10. In the illustrated example, aircraft 10 includes an airframe 11 including a fuselage 20, landing gear 30, reconfigurable wing 40 extending from a port side of aircraft 10, and reconfigurable wing 50 extending from a starboard side of aircraft 10. Fuselage 20 includes cockpit 25 which is configured to accommodate a pilot or other human occupant of aircraft 10. It shall be appreciated that other example embodiments of aircraft according to the present disclosure may vary from the illustrated example and may, for example, be configured as unpiloted or unmanned aircraft which may omit cockpits and/or other human occupancy compartments or spaces as well as with various alternative airframes, fuselages, landing gear, reconfigurable wings, and other components and systems.

Aircraft 10 is configured and operable to fly in a vertical take-off and landing (VTOL) mode, a forward flight mode, and a transition mode during transitions between the VTOL mode and the forward flight mode. Operation of aircraft 10 may include repositioning a wing or wing segment even while in flight in order to alter its breadth in order to accommodate smaller takeoff and landing areas. A push propeller 35 is operatively coupled with airframe 11 and configured to provide thrust in a forward direction during the forward flight mode and transition mode. In other embodiments a traditional propeller may be provided at the front end of the airframe or on-wing of the airframe. Lift fans 31, 32, 33, 34 are operatively coupled with airframe 11 and configured to provide thrust in a vertical direction during the VTOL mode and the transition mode. Lift fans 31, 32, 33, 34 may be configured and provided with fixed-pitch propeller blades optimized for vertical flight and may be reconfigured from a VTOL position wherein the propeller blades are positioned to extend in opposite directions such as illustrated in FIGS. 1-3 to a forward flight position wherein the propeller blades are positioned to extend in substantially the same direction and are oriented in a swept back, low resistance orientation such as illustrated in FIG. 4.

A power source 27 is carried by airframe 11 and is configured and operable to selectably provide power to push propeller 35 and lift fans 31, 32, 33, 34. In the illustrated example, power source 27 is configured and provided in a form comprising one or more electrochemical batteries and associated power electronics configured to supply power to a plurality of electric machines operatively coupled with and configured to drive push propeller 35 and lift fans 31, 32, 33, 34, respectively. In other embodiments, power source 27 may be configured and provided in other forms including one or more fuel tanks and other mechanisms, such as combustion engines, may be operatively coupled with and configured to drive push propeller 35 and lift fans 31, 32, 33, 34.

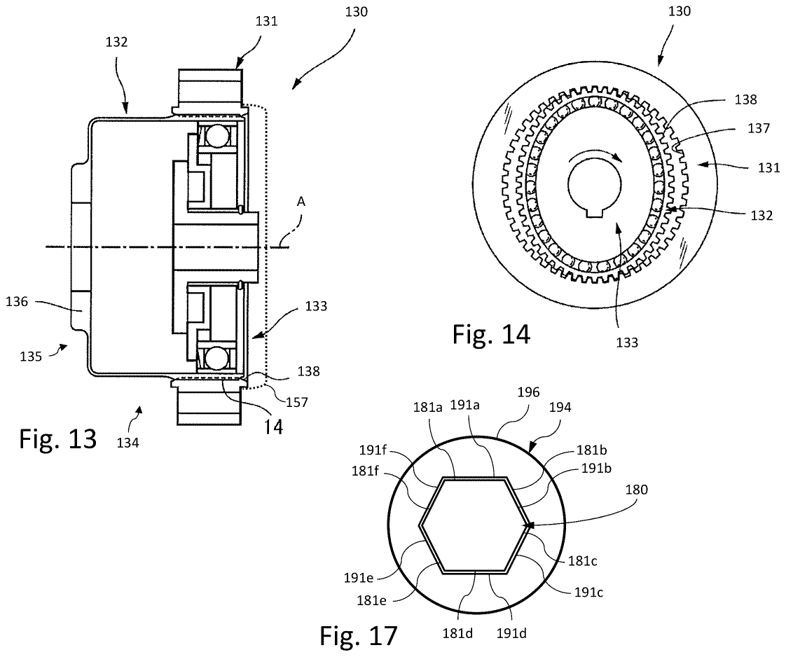

As illustrated in FIG. 1, reconfigurable wing 40 and reconfigurable wing 50 may be selectably adjusted to a retracted stowage position to reduce minimize the lateral space requirements for stowing aircraft 10. In the retracted stowage position of FIG. 1, adjustable wing portion 46 has been rotated relative to fixed wing portion 42, about hinge mechanism 44 to a retracted stowage position, and adjustable wing portion 56 has been rotated relative to fixed wing portion 52, about hinge mechanism 54 to a retracted stowage position. It shall be appreciated that reconfigurable wing 40 and reconfigurable wing 50 may be selectably adjusted to other retracted stowage positions. For example, in the embodiment illustrated in FIG. 16, an adjustable wing portion 46′ may be rotated relative to a fixed wing portion 42′, about hinge mechanism 44′ to a retracted stowage position wherein adjustable wing portion 46′ is substantially flush with a fixed wing portion 42′.

As illustrated in FIG. 2, reconfigurable wing 40 and reconfigurable wing 50 may be selectably adjusted to a vertical flight retracted position during VTOL mode operation of aircraft 10. In the vertical flight retracted position of FIG. 2, adjustable wing portion 46 has been rotated relative to fixed wing portion 42, about hinge mechanism 44 to a vertical flight retracted position, and adjustable wing portion 56 has been rotated relative to fixed wing portion 52, about hinge mechanism 54 to a vertical flight retracted position. It shall be appreciated that reconfigurable wing 40 and reconfigurable wing 50 may be selectably adjusted to other vertical flight retracted positions. It shall be appreciated that the vertical flight retracted position during VTOL mode operation of aircraft 10 may comprise greater inward rotation of the reconfigurable wing 50 than the position illustrated in FIG. 2.

As illustrated in FIGS. 3 and 4, reconfigurable wing 40 and reconfigurable wing 50 may be selectably adjusted to a deployed position during forward flight mode operation of aircraft 10. In the deployed position of FIGS. 3 and 4, adjustable wing portion 46 has been rotated relative to fixed wing portion 42, about hinge mechanism 44 to a deployed position, and adjustable wing portion 56 has been rotated relative to fixed wing portion 52, about hinge mechanism 54 to a deployed position. It shall be appreciated that reconfigurable wing 40 and reconfigurable wing 50 may be selectably adjusted to other deployed positions. It shall be appreciated that, in a deployed position, reconfigurable wing 40 and reconfigurable wing 50 are configured to provide lift to aircraft 10.

During transitions between stowage mode and VTOL mode reconfigurable wing 40 and reconfigurable wing 50 may be selectably adjusted between a retracted stowage position (such as the retracted position illustrated in FIG. 1 or another retracted stowage position) and a retracted flight position (such as the deployed position illustrated in FIG. 2 or another retracted flight position). Such transition may be utilized to allow aircraft 10 to be stowed in smaller stowage spaces. During transitions between VTOL mode and forward flight mode of operation of aircraft 10, reconfigurable wing 40 and reconfigurable wing 50 may be selectably adjusted between a retracted flight position (such as the retracted position illustrated in FIG. 2 or another retracted position) and a deployed flight position (such as the deployed position illustrated in FIGS. 3 and 4 or another deployed position). Such transition may be utilized to allow aircraft 10 to take off and land in confined air columns, for example, urban environments, highways, forests or industrial environments and transition to forward flight rapidly once aircraft has cleared potential obstructions.

Reconfigurable wing 40 and reconfigurable wing 50 are fixedly coupled with respective sides of fuselage 20 and extend laterally in substantially opposite directions from fuselage 20. In certain respects, reconfigurable wing 40 and reconfigurable wing 50 may be mirror-image identical. Accordingly, it shall be appreciated that the description herein of the components, functions, and structures of reconfigurable wing 40 is also applicable to reconfigurable wing 50.

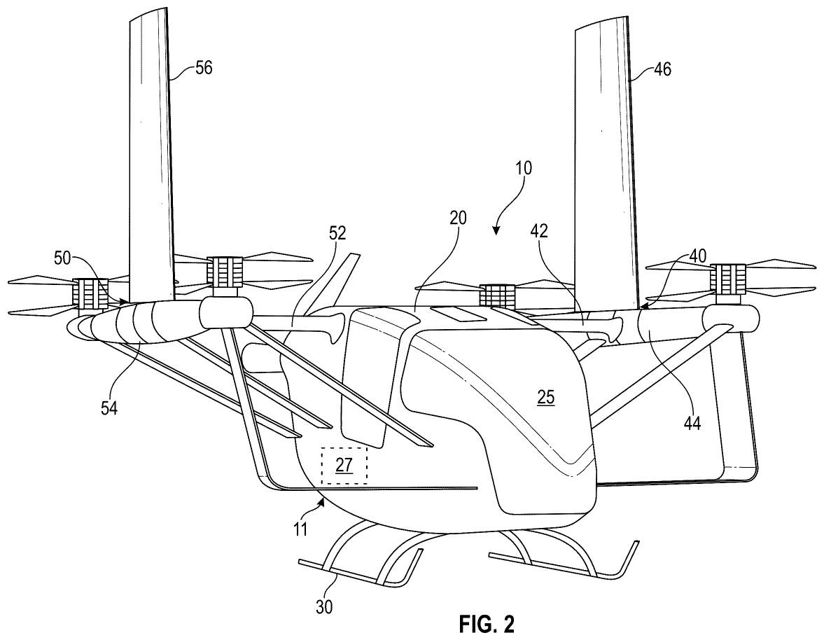

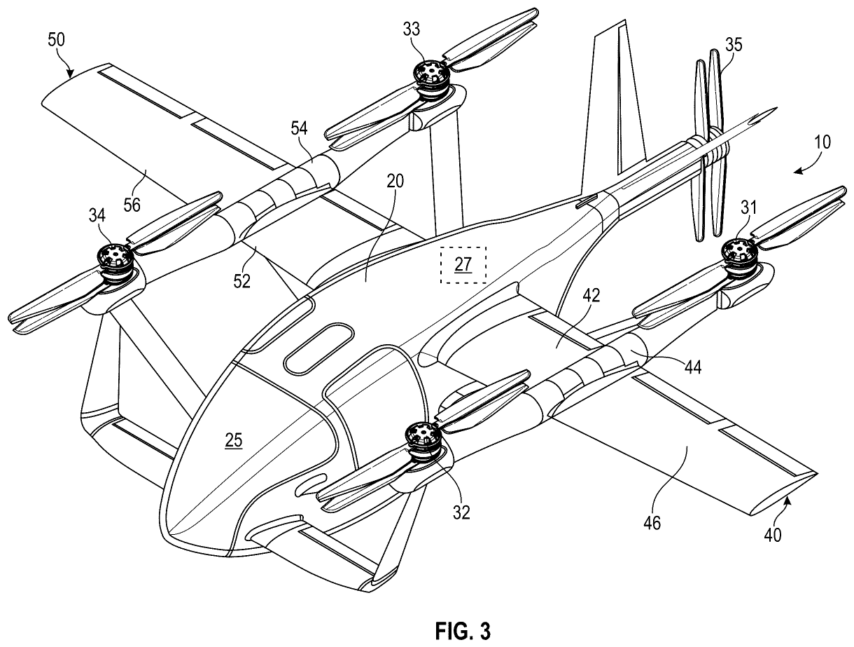

As further illustrated in FIGS. 5 and 6, reconfigurable wing 40 includes a fixed wing portion 42, a hinge mechanism 44, and an adjustable wing portion 46. Fixed wing portion 42 is fixedly coupled with and extends laterally from fuselage 20 of airframe 11. Adjustable wing portion 46 extends from and is adjustably coupled with fixed wing 42 portion by hinge mechanism 44.

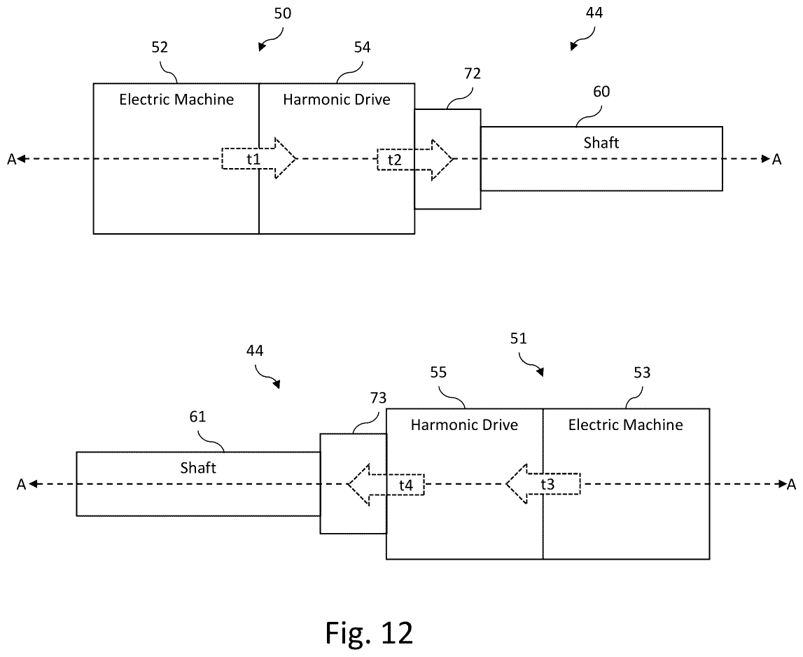

In FIG. 5, reconfigurable wing 40 is illustrated in an example retracted configuration. In the illustrated retracted configuration, adjustable wing portion 46 is rotated to extend vertically upward in a direction generally perpendicular to the lateral extending direction of fixed wing portion 42. Other retracted configurations are also contemplated. In some retracted configurations, adjustable wing portion 46 is further rotated inward toward fuselage 20 such that adjustable wing portion 46 is at an acute angle relative to fixed wing portion 42. In some retracted configurations, adjustable wing portion 46 is rotated further inward such that it contacts or lies flat relative to fixed wing portion 42. For example, as illustrated in FIGS. 15 and 16, an adjustable wing portion 46′ may be rotatably coupled with a fixed wing portion 42′ by a hinge mechanism 44′ which is configured and provided in the form of a piano-type hinge or a door-type hinge mechanism. In such embodiments, adjustable wing portion 46′ may be rotated from a deployed flight position illustrated in FIG. 15, to retracted flight position (intermediate the position illustrated in FIG. 15 and the position illustrate in FIG. 16), to a retracted stowage position wherein adjustable wing portion 46′ is substantially flush with fixed wing portion 42′ as illustrated in FIG. 16. It shall be appreciated that hinge mechanism 44′ may be operatively coupled with a drive assembly to provide an off-centerline configuration hinge mechanism and drive assembly providing increased rotation relative to on-centerline arrangements.

In FIG. 6, reconfigurable wing 40 is illustrated in an example deployed configuration. In the illustrated deployed configuration, adjustable wing portion 46 is rotated to extend in a direction generally corresponding to the lateral extending direction of fixed wing portion 42. Other deployed configurations are also contemplated. In some deployed configurations, adjustable wing portion 46 is rotated upward and inward toward fuselage 20 such that adjustable wing portion 46 extends upward from and is at an obtuse angle relative to fixed wing portion 42 as may be desirable for some forward flight mode conditions or for some transition mode conditions. In some retracted configurations, adjustable wing portion 46 is rotated downward and inward toward fuselage 20 such that adjustable wing portion 46 extends downward from and at an obtuse angle relative to fixed wing portion 42 as may be desirable for some forward flight mode conditions or for some transition mode conditions.

It shall be appreciated that movement of adjustable wing portion 46 between a retracted position and a deployed position may be performed in response to a pilot input provided via a fly-by-wire or other flight control system and/or by an autopilot implemented in an electronic control system. It shall be further appreciated that an electronic control system of aircraft 10 may be configured and provided with flight management software configured and operable to vary and optimize aerosurfaces of reconfigurable wing 40 and operation of electric machines thereof for most efficient flight as a function of phase of flight, altitude, airspeed and mission type.

In some embodiments, reconfigurable wing 40 and reconfigurable wing 50 may be controlled to have corresponding or matching angular rates of portions and corresponding or matching adjustment endpoints as the outer wing segments are commanded between positions. In some embodiments, reconfigurable wing 40 and reconfigurable wing 50 may be controlled to have staged or staggered operation, such as when one reconfigurable wing segment is to fold on top of another reconfigurable wing segment when fully stowing the reconfigurable wing segments.

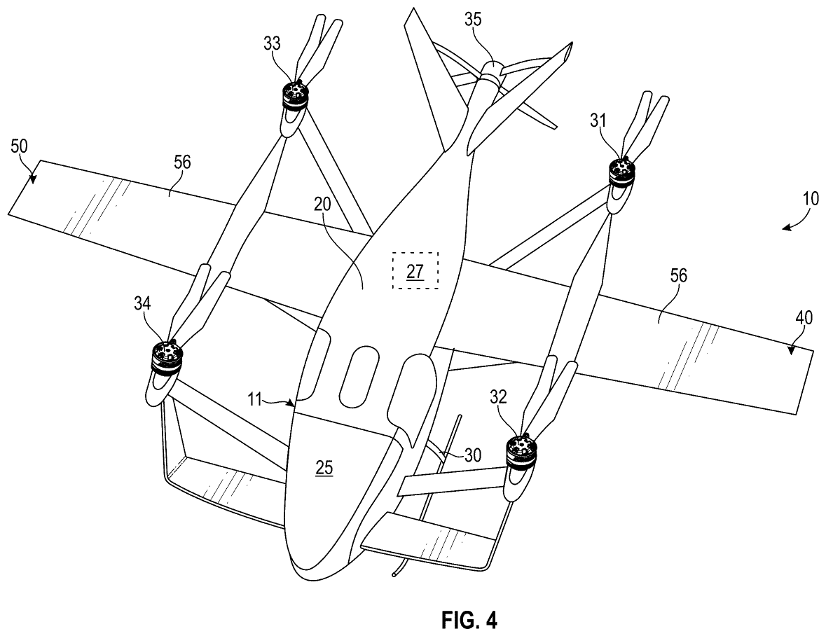

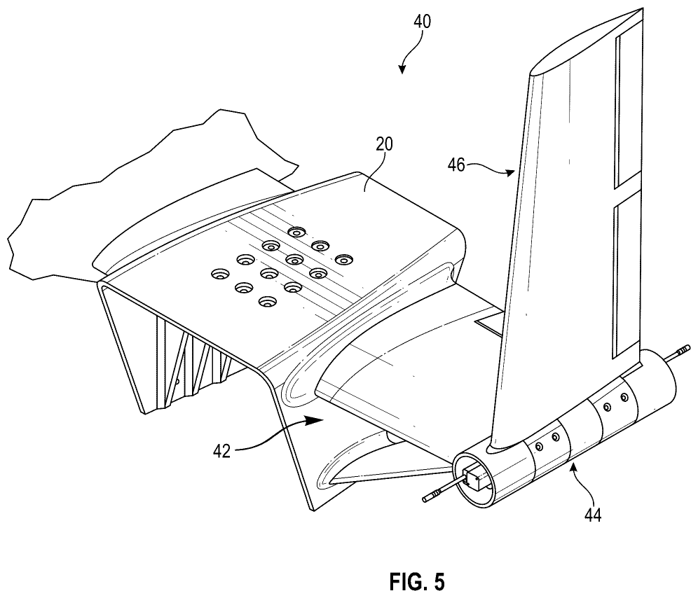

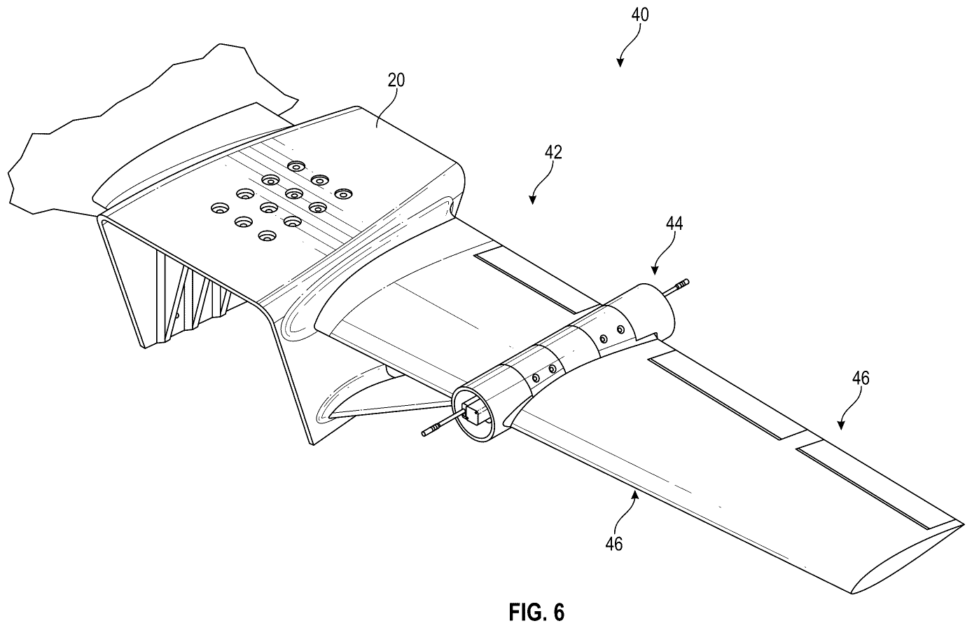

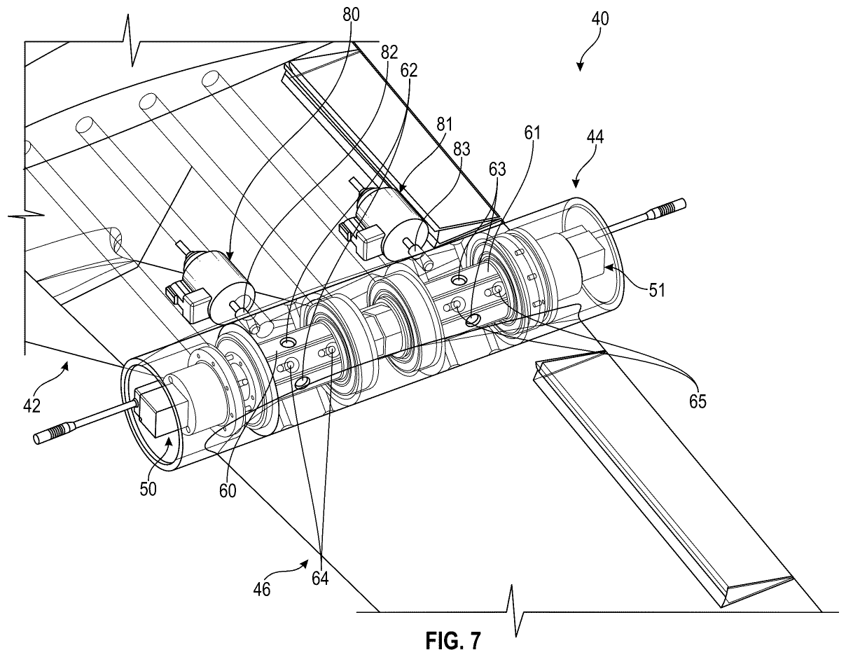

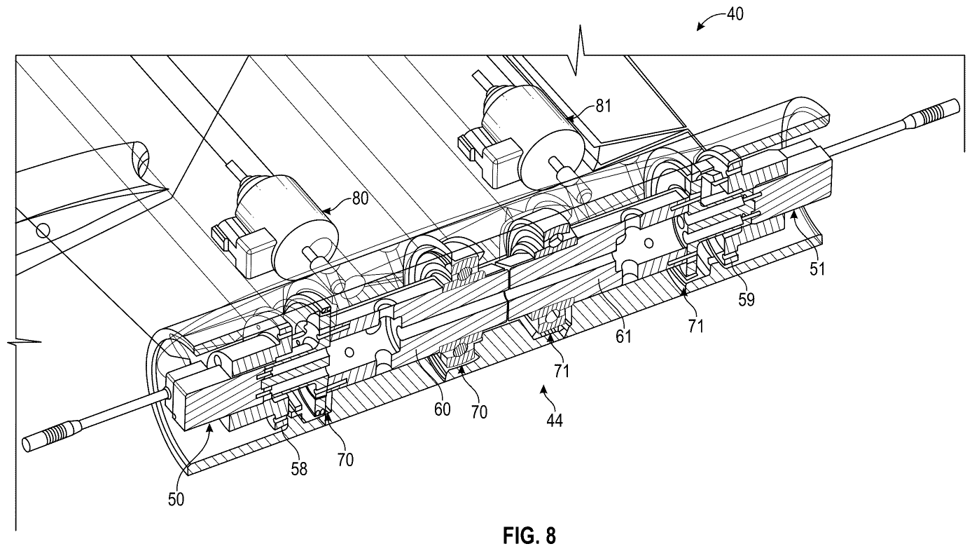

As further illustrated in FIGS. 7-14, hinge mechanism 44 includes drive assembly 50, drive assembly 51, shaft 60, shaft 61, bearing system 70, and bearing system 71. In the illustrated example, drive assembly 50, drive assembly 51, shaft 60, shaft 61, bearing system 70, and bearing system 71 are contained in a common nacelle defined by outer surfaces of hinge mechanism 44. Drive assembly 50 is positioned at a leading or forward location of reconfigurable wing 40 and is generally coaxial with shaft 60 which extends from the leading or forward location rearward along reconfigurable wing 40 to shaft 61. Drive assembly 51 is positioned at a trailing or rearward location of reconfigurable wing 40 and is generally coaxial with shaft 61 which extends from the trailing or rearward location forward along reconfigurable wing 40 to shaft 60.

In some embodiments, shaft 60 may be operatively coupled with shaft 61 to provide force transfer promoting co-rotation thereof. In some embodiments, shaft 60 may adjoin, be adjacent with, or spaced apart from shaft 61 to provide independent rotation thereof without minimal or no force transfer therebetween. In some embodiments, shaft 60 and shaft 61 may be provided as a single or unitary shaft structure rather than as separate pieces. In the illustrated example, shaft 60 and shaft 61 are configured and provided as generally tubular shafts including hollow interiors effective to reduce the weight thereof relative to solid shaft, although the use of solid shafts is contemplated in some examples.

In the illustrated example, shaft 60 is configured and provided with a generally octagonal cross section including eight outward facing surfaces over at least a portion of its length. A plurality of sockets 62 are provided in different ones of the outward facing surfaces at spaced apart locations about the periphery of shaft 60. When shaft 60 is adjusted to a predetermined position aligning one of the plurality of receptacles with locking pin 82 of actuator 80, actuator 80 can be controlled to extend locking pin 82 into locking engagement with an aligned one of sockets 62 effective to lock shaft 60 in the aligned position. In the illustrated example, at least two sockets 62 are provided in shaft 60 and are offset from one another by 90 degrees. This arrangement allows shaft 60 to be selectably locked in a first position corresponding to a deployed position of adjustable wing portion 46 and to be selectably locked in a second position corresponding to a deployed position of adjustable wing portion 46. Fastener receptables 62 are also provided in at least one surface of shaft 60 and are configured to receive fasteners such as bolts in order to coupled adjustable wing portion 46 to shaft 60. In other embodiments, other types of locking mechanisms may be utilized including, for example, a clutch-brake mechanism which may be configured and provided in a centerline relationship with a respective hinge mechanism. Some embodiments may include a clutch-brake mechanism including an integrated position encoder or sensor.

In the illustrated example, shaft 61 is configured and provided with a generally octagonal cross section including eight outward facing surfaces over at least a portion of its length. Other multi-facing surfaces are applicable for engagement or the utilization of a mechanical fastener (e.g., a pin/bolt arrangement). Also, a spline or combination of rotated multi-surface geometry (e.g., a double hex, or 12-point configuration) may be utilized. A plurality of sockets 63 are provided in different ones of the outward facing surfaces at spaced apart locations about the periphery of shaft 61. When shaft 61 is adjusted to a predetermined position aligning one of the plurality of receptacles with locking pin 83 of actuator 81, actuator 81 can be controlled to extend locking pin 83 into locking engagement with an aligned one of sockets 63 effective to lock shaft 61 in the aligned position. In the illustrated example, at least two sockets 63 are provided in shaft 60 and are offset from one another by 90 degrees. This arrangement allows shaft 61 to be selectably locked in a first position corresponding to a deployed position of adjustable wing portion 46 and to be selectably locked in a second position corresponding to a deployed position of adjustable wing portion 46. Fastener receptables 65 are also provided in at least one surface of shaft 60 and are configured to receive fasteners such as bolts in order to couple adjustable wing portion 46 to shaft 61.

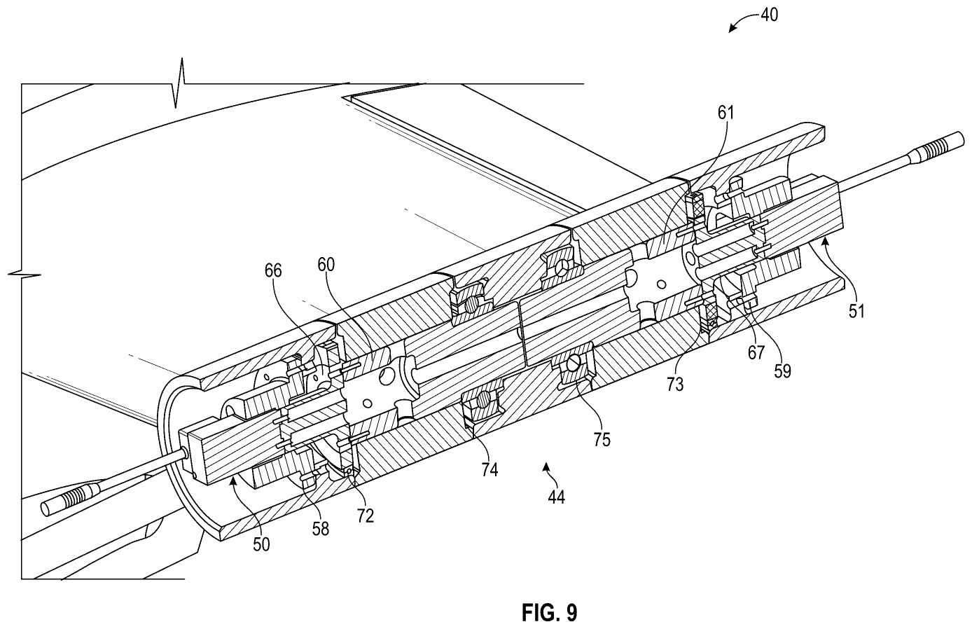

Drive assembly 50 includes electric machine 52 which is operatively coupled with and configured to transmit torque to rotate an input shaft of a harmonic drive 54, for example, as schematically depicted in FIG. 12 by arrow t1. Harmonic drive 54 is operatively coupled with and configured to rotate flange adapter 66 and shaft 60, for example, as schematically depicted in FIG. 12 by arrow t2. Electric machine 52 may be operated to drive rotation of harmonic drive 54 to, in turn, drive rotation of flange adapter 66 and shaft 60 about axis A-A to adjust positioning of adjustable wing portion 46 relative to fixed wing portion 42. Drive assembly 50 is supported by and fixedly coupled with fixed wing portion 42 by drive housing 58.

Drive assembly 51 includes electric machine 53 which is operatively coupled with and configured to transmit torque to rotate an input shaft of a harmonic drive 55, for example, as schematically depicted in FIG. 12 by arrow t3. Harmonic drive 55 is operatively coupled with and configured to rotate flange adapter 66 and shaft 61, for example, as schematically depicted in FIG. 12 by arrow t4. Electric machine 53 may be operated to drive rotation of harmonic drive 55 to, in turn, drive rotation of flange adapter 66 and shaft 61 about axis A-A to adjust positioning of adjustable wing portion 46 relative to fixed wing portion 42. Drive assembly 51 is supported by and fixedly coupled with fixed wing portion 42 by drive housing 59.

Drive assembly 50 and drive assembly 51 may be configured and provided with a closed-loop position sensing system including a position encoder, a mechanical indexing feature in combination with a force sensor, a clutch brake position sensor, or another type of sensor as will occur to one of skill in the art with the benefit and insight of the present disclosure. Such closed-loop position sensing systems may be configured and utilized to ensure that drive assembly 50 and drive assembly 51 are adjusted to the same rotational position and may also be utilized to ensure that drive assemblies on an opposing wing are adjusted to a mirror image rotational position. Such coordination may be provided using software-based counting of feedback signals to coordinate operation of respective drive assemblies.

Bearing system 70 includes bearing 74 which includes an inner race coupled with shaft 60 and an outer race fixedly coupled with fixed wing portion 42 and rolling elements (such as balls or rollers) positioned therebetween. In some forms, bearing 74 may be configured and provided in the form of a bushing, sometimes also referred to as a journal bearing plain bearing, sleeve bearing, or sliding bearing. An inner surface of the inner race of bearing 74 is configured and provided with as a generally hexagonal cross section including eight inward facing surfaces which are configured to snugly and matingly receive a section of shaft 60 which is provided with a corresponding hexagonal cross section. Bearing system 70 includes bearing 72 which includes an inner race coupled with flange adapter 66, an outer race fixedly coupled with fixed wing portion 42 and rolling elements (such as balls or rollers) positioned therebetween. Flange adapter 66 is operatively coupled with shaft 60 on one side and is operatively coupled with harmonic drive 54 of drive assembly 50 on another side.

Bearing system 71 includes bearing 75 which includes an inner race coupled with shaft 61 and an outer race fixedly coupled with fixed wing portion 42 and rolling elements (such as balls or rollers) positioned therebetween. In some forms, bearing 75 may be configured and provided in the form of a bushing, sometimes also referred to as a journal bearing plain bearing, sleeve bearing, or sliding bearing. An inner surface of the inner race of bearing 75 is configured and provided with as a generally hexagonal cross section including eight inward facing surfaces which are configured to snugly and matingly receive a section of shaft 61 which is provided with a corresponding hexagonal cross section. Bearing system 71 includes bearing 73 which includes an inner race coupled with flange adapter 67, an outer race fixedly coupled with fixed wing portion 42 and rolling elements (such as balls or rollers) positioned therebetween. Flange adapter 67 is operatively coupled with shaft 67 on one side and is operatively coupled with harmonic drive 55 of drive assembly 51 on another side.

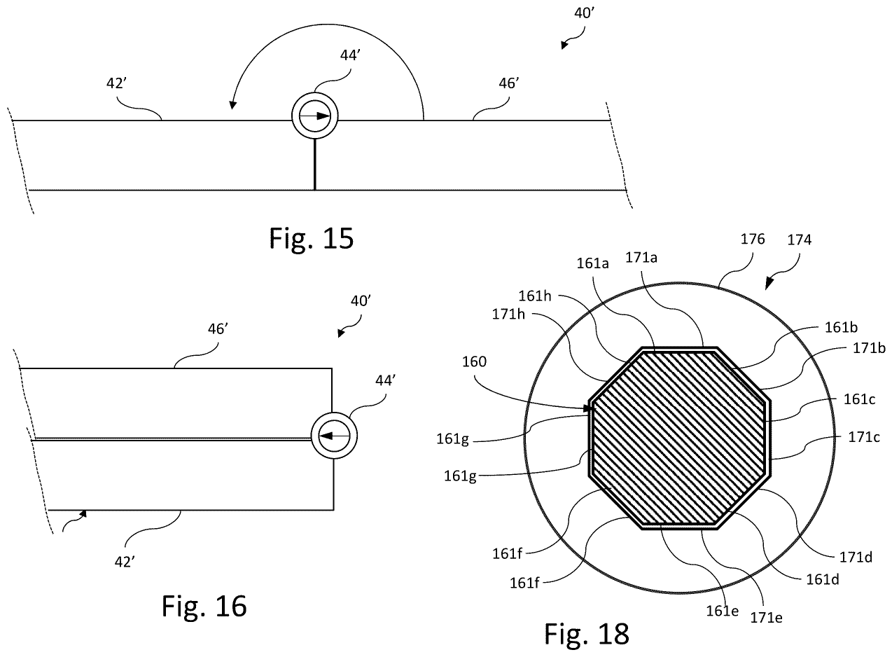

With additional reference to FIG. 17, there is illustrated an example interface between a shaft 180 and an inner race 196 of a bearing 194. It shall be appreciated that shaft 180 may be considered a generalized form of shaft 60 and/or shaft 61 and that the description of shaft 180 and its various forms and embodiments is applicable to shaft 60 and/or shaft 61. It shall be appreciated that bearing 194 and inner race 196 may be considered a generalized form of bearing 74 and the inner race thereof and/or bearing 75 and the inner race thereof and that the description of bearing 194 and inner race 196 and their various forms and embodiments is applicable to bearing 74 and the inner race thereof and/or bearing 75 and the inner race thereof.

Shaft 180 is configured and provided with a plurality of shaft flat sections about its outer periphery. In the illustrated example, the plurality of shaft flat sections are configured and provided in the form outward facing surfaces 181a-181f provided over at least a portion of shaft 180 and having a generally hexagonal arrangement. Outward facing surfaces 181a-181f are one example of a plurality of shaft flat sections arranged in a polygonal shape. A number of other configurations of shaft flat sections arranged in a polygonal shape are also contemplated. For example, some embodiments of shaft 180 may include three or more outward facing surfaces having a generally triangular, square or rectangular, pentagonal, or other higher order polygonal arrangement, as well as irregular polygonal shapes and arrangements. It shall be further appreciated that generally polygonal arrangements of shaft flat sections according to the present disclosure may be configured and provided such that the shaft flat sections form a closed or complete polygonal shape, such as in the illustrated example. In other embodiments, the shaft flat sections form may extend over portions of respective faces of a polygonal shape with gaps or deviations from the polygonal shape present in other portions of one or more of the respective faces, such as in the examples illustrated in FIGS. 7-11. It shall also be appreciated that shaft 180 may be configured and provided with other forms and arrangements of a plurality of shaft flat sections such as, for example, flat shaft sections of keyed, splined, toothed, or other suitable exterior surfaces of shaft 180 as will occur to one of skill in the art with the benefit and insight of the present disclosure.

Inner race 196 of bearing 194 is configured and provided with a plurality of bearing member flat sections about its inner periphery. In the illustrated example, the plurality of bearing member flat sections are configured and provided in the form inward facing surfaces 171a-171h provided over at least a portion of an inner surface of inner race 196 and having a generally hexagonal arrangement. Inward facing surfaces 171a-171h are one example of a plurality of bearing member flat sections are arranged in a polygonal shape. A number of other configurations of bearing member flat sections arranged in a polygonal shape are also contemplated. For example, some embodiments of inner race 196 may include three or more inward facing surfaces having a generally triangular, square or rectangular, pentagonal, or other higher order polygonal arrangement, as well as irregular polygonal shapes and arrangements. It shall be further appreciated that generally polygonal arrangements of bearing member flat sections according to the present disclosure may be configured and provided such that the bearing member flat sections form a closed or complete polygonal shape, such as in the illustrated example. In other embodiments, the bearing member flat sections form may extend over portions of respective faces of a polygonal shape with gaps or deviations from the polygonal shape present in other portions of one or more of the respective faces, such as in the examples illustrated in FIGS. 7-11. It shall also be appreciated that inner race 196 may be configured and provided with other forms and arrangements of a plurality of shaft flat sections such as, for example, flat shaft sections of keyed, splined, toothed, or other suitable interior surfaces of inner race 196 as will occur to one of skill in the art with the benefit and insight of the present disclosure.

It shall be appreciated that the cooperating and interfacing arrangement of outward facing surfaces 181a-181f and inward facing surfaces 171a-171h is depicted in FIGS. 7-11 with an intermediate gap for clarity of illustration. In certain preferred embodiments the cooperating and interfacing arrangement of outward facing surfaces 181a-181f and inward facing surfaces 171a-171h may omit all or a portion of the depicted intermediate gap and may comprise direct contact and engagement of the cooperating and interfacing arrangement of outward facing surfaces 181a-181f and inward facing surfaces 171a-171h. The same may also be true of the other forms and examples of cooperating and interfacing arrangements of shaft flat sections and bearing member flat sections disclosed herein. It shall be further appreciated that the cooperating and interfacing arrangements of outward facing surfaces 181a-181f and inward facing surfaces 171a-171h and of shaft flat sections and bearing member flat sections disclosed herein may prevent slippage or rotation of shaft 180 relative to inner race 196 of bearing 194 and may maintain orientation and position of shaft 180 relative to inner race 196 of bearing 194 without requiring press fitting thereof.

With additional reference to FIG. 18, there is illustrated another example interface between a shaft 160 and an inner race 176 of a bearing 174. It shall be appreciated that shaft 160 may be considered a generalized form of shaft 60 and/or shaft 61 and that the description of shaft 160 and its various forms and embodiments is applicable to shaft 60 and/or shaft 61. It shall be appreciated that bearing 174 and inner race 176 may be considered a generalized form of bearing 74 and the inner race thereof and/or bearing 75 and the inner race thereof and that the description of bearing 174 and inner race 176 and their various forms and embodiments is applicable to bearing 74 and the inner race thereof and/or bearing 75 and the inner race thereof.

Shaft 160 is configured and provided with a plurality of shaft flat sections about its outer periphery. In the illustrated example, the plurality of shaft flat sections are configured and provided in the form outward facing surfaces 161a-161h provided over at least a portion of shaft 160 and having a generally octagonal arrangement. Outward facing surfaces 161a-161h are one example of a plurality of shaft flat sections arranged in a polygonal shape. A number of other configurations of shaft flat sections arranged in a polygonal shape are also contemplated. For example, some embodiments of shaft 160 may include three or more outward facing surfaces having a generally triangular, square or rectangular, pentagonal, hexagonal, heptagonal, or other higher order polygonal arrangement, as well as irregular polygonal shapes and arrangements. It shall be further appreciated that generally polygonal arrangements of shaft flat sections according to the present disclosure may be configured and provided such that the shaft flat sections form a closed or complete polygonal shape, such as in the illustrated example. In other embodiments, the shaft flat sections form may extend over portions of respective faces of a polygonal shape with gaps or deviations from the polygonal shape present in other portions of one or more of the respective faces, such as in the examples illustrated in FIGS. 7-11. It shall also be appreciated shaft 160 may be configured and provided with other forms and arrangements of a plurality of shaft flat sections such as, for example, flat shaft sections of keyed, splined, toothed, or other suitable exterior surfaces of shaft 160 as will occur to one of skill in the art with the benefit and insight of the present disclosure.

Inner race 176 of bearing 174 is configured and provided with a plurality of bearing member flat sections about its inner periphery. In the illustrated example, the plurality of bearing member flat sections are configured and provided in the form inward facing surfaces 171a-171h provided over at least a portion of an inner surface of inner race 176 and having a generally octagonal arrangement. Inward facing surfaces 171a-171h are one example of a plurality of bearing member flat sections are arranged in a polygonal shape. A number of other configurations of bearing member flat sections arranged in a polygonal shape are also contemplated. For example, some embodiments of inner race 176 may include three or more inward facing surfaces having a generally triangular, square or rectangular, pentagonal, hexagonal, heptagonal, or other higher order polygonal arrangement, as well as irregular polygonal shapes and arrangements. It shall be further appreciated that generally polygonal arrangements of bearing member flat sections according to the present disclosure may be configured and provided such that the bearing member flat sections form a closed or complete polygonal shape, such as in the illustrated example. In other embodiments, the bearing member flat sections form may extend over portions of respective faces of a polygonal shape with gaps or deviations from the polygonal shape present in other portions of one or more of the respective faces, such as in the examples illustrated in FIGS. 7-11. It shall also be appreciated that inner race 176 may be configured and provided with other forms and arrangements of a plurality of shaft flat sections such as, for example, flat shaft sections of keyed, splined, toothed, or other suitable interior surfaces of inner race 176 as will occur to one of skill in the art with the benefit and insight of the present disclosure.

It shall be appreciated that the cooperating and interfacing arrangement of outward facing surfaces 161a-161h and inward facing surfaces 171a-171h is depicted in FIGS. 7-11 with an intermediate gap for clarity of illustration. In certain preferred embodiments the cooperating and interfacing arrangement of outward facing surfaces 161a-161h and inward facing surfaces 171a-171h may omit all or a portion of the depicted intermediate gap and may comprise direct contact and engagement of the cooperating and interfacing arrangement of outward facing surfaces 161a-161h and inward facing surfaces 171a-171h. The same may also be true of the other forms and examples of cooperating and interfacing arrangements of shaft flat sections and bearing member flat sections disclosed herein. It shall be further appreciated that the cooperating and interfacing arrangements of outward facing surfaces 161a-161h and inward facing surfaces 171a-171h and of shaft flat sections and bearing member flat sections disclosed herein may prevent slippage or rotation of shaft 160 relative to inner race 176 of bearing 174 and may maintain orientation and position of shaft 160 relative to inner race 176 of bearing 174 without requiring press fitting thereof.

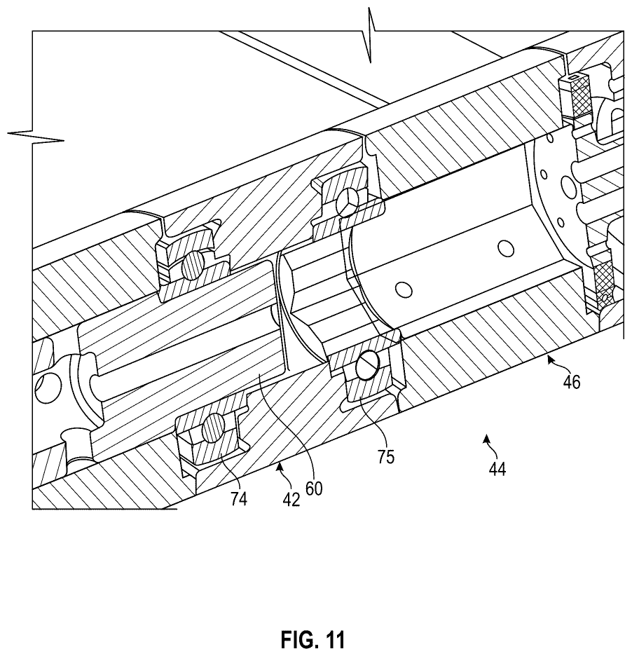

With reference to FIGS. 14 and 15, there are illustrated certain aspects of an example embodiment of harmonic drive 130 which is one example of a harmonic drive or strain wave drive, sometimes referred to as harmonic gearing or strain wave gearing, according to the present disclosure. It shall be appreciated that harmonic drive 54 and harmonic drive 55 may be configured and provided in the form of harmonic drive 130. In other examples, harmonic drive 54 and harmonic drive 55 may be configured and provided in the form of other harmonic drives as will occur to one of skill in the art with the benefit and insight of the present disclosure.

Harmonic drive 130 includes a rigid internally toothed gear 131. A flexible externally toothed gear 132, sometimes referred to as a flexspline, is positioned inside the rigid internally toothed gear 131 in generally concentric relationship. A wave generator 133 is positioned inside the flexible externally toothed gear 132 and is operatively coupled with and configured to receive torque from an electric machine in either a forward or a reverse direction. The flexible externally toothed gear 132 includes a flexible cylindrical body 134, a diaphragm 135 extending radially inward from one end of the cylindrical body in the direction of the center axis line 1 a, and a rigid boss 136 continued to the inner peripheral edge of the diaphragm 135.

A portion of the flexible cylindrical body 134 of the flexible externally toothed gear 132 where external teeth 138 are formed is flexed by the wave generator 133 into an ellipsoidal shape, whereby the external teeth 138 located on both ends in the major-axis direction of the ellipsoidal shape are meshed with internal teeth 137 of the rigid internally toothed gear 131. Because the difference in number of teeth between gears 131 and 132 is 2x where x is a positive integer, the meshing positions between gears 131 and 132 move circumferentially to generate relative rotation between the gears according to the difference in number of teeth when the wave generator 133 is rotated by an electric machine. The rigid internally toothed gear 131 is fixed so as not to rotate relative to the fixed wing portion 42.

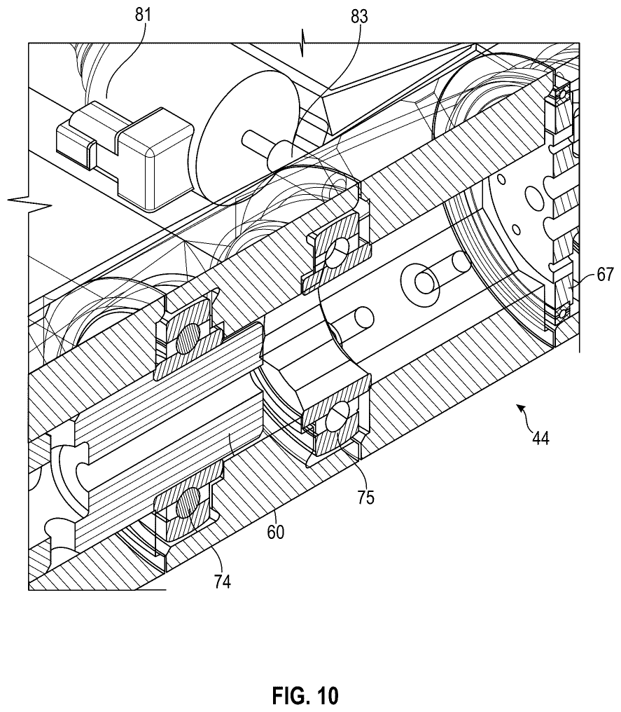

In the illustrated example, harmonic drive 130 is operatively coupled with a spring mechanism 157 (depicted schematically in FIG. 13) which is configured to offset or assist with torsional loading on the harmonic drive. Spring mechanism 157 may be configured and provide in a number of forms such as, for example, as an assembly including one or more clock springs, torsional springs, extension springs wrapped around a mandrel, air springs, air struts, or combinations of the foregoing and/or and other suitable springs as will occur to one of skill in the art with the benefit and insight of the present disclosure. Such assemblies or mechanisms may be operatively coupled with one or both of a drive side and a driven side of harmonic drive 130 and may be operatively coupled with a one or more fixed structures of harmonic drive 130 or adjacent structures which may provide reaction force for spring mechanism 157. Such assemblies and mechanisms may be configured and operable to offset and/or assist with torsional loads imposed on harmonic drive 130, for example, due to gravity, wind force, or other external forces, any may be effective to reduce wear, improve performance, and extend life of harmonic drive 130.

It shall be appreciated that harmonic drive 130 and other harmonic drives according to the present disclosure may provide precise and rigid stabilization of the outer wing segments, such as adjustable wing portion 46, even under turbulent airflow conditions which may occur, for example, during taking off when lift fans of aircraft 10 are operated at or near maximum thrust, or when strong crosswinds are present. Harmonic drive 130 and other harmonic drives according to the present disclosure may provide zero or substantially zero backlash, high torque density, high positional accuracy, high positional repeatability, high torsional stiffness, and a compact form factor.

Harmonic drive 130 and other harmonic drives according to the present disclosure may contribute to precise and safe repositioning of a wing segment while in flight to accommodate tight landing conditions. Use of a harmonic drive in combination with a locking mechanism allows adjustable wing potions to be fixed at predetermined positions, for example, a zero-degree offset deployed position, a 90 degree offset retracted position, or other predetermined offset positions while ensuring little to no drift of adjustable wing portions and predictable aerodynamic performance during takeoff and landing operations and transitions thereto or therefrom. In some embodiments, multiple harmonic drives can be in series for distributing the torque requirements or increasing the torque base on size and application.

It shall be appreciated that hinge mechanisms and harmonic drives according to the present disclosure may be utilized in connection with a number of other adjustable or reconfigurable aircraft or airframe structures. Such hinge mechanisms and harmonic drives may be utilize, for example, in connection with moveable tailboom structures adjustable to close positions for normal flight and to open positions permitting ingress and egress from while stationary or potentially during flight, adjustable radar domes or antenna structures, aircraft doors or ramps, aircraft flight control surfaces, and other adjustable or reconfigurable aircraft or airframe structures as will occur to one of skill in the art with the benefit and insight of the present disclosure.

While various aspects of the present disclosure have been described in connection with aircraft 10, it shall be appreciated that the unique apparatuses, processes, and systems disclosed herein are not so limited and may be implemented and utilized in connection with other applications, for example, automotive applications, other aerospace applications, other underwater applications and other transportation applications such as rail, ship, or boat applications.

As illustrated by this detailed description, the present disclosure contemplates a plurality of embodiments including the following example embodiments.

Example embodiment 1 is an aircraft comprising: a fuselage; and a reconfigurable wing including a fixed wing portion fixedly coupled with and extending laterally from the fuselage and an adjustable wing portion extending from and adjustably coupled with the fixed wing portion by a hinge mechanism configured to provide rotation of at least a portion of the adjustable wing portion relative to the fixed wing portion during in-flight operation of the aircraft, the hinge mechanism including a bearing including a first bearing member coupled with the fixed wing portion and a second bearing member rotatably coupled with the first bearing member and fixedly coupled with the shaft at an interface between a plurality of bearing member flat sections of the second bearing member and a plurality of shaft flat sections of the shaft, and a drive assembly including an electric machine operatively coupled with and configured to drive the shaft of the hinge mechanism to adjust positioning of the adjustable wing portion relative to the fuselage.

Example embodiment 2 includes the features of example embodiment 1, wherein the plurality of shaft flat sections are arranged in a polygonal shape and the plurality of bearing member flat sections are arranged in a parallel mating arrangement contacting the plurality of shaft flat sections.

Example embodiment 3 includes the features of example embodiment 1, wherein the adjustable wing portion is adjustable to an extended position wherein the adjustable wing portion is oriented in substantially the same direction as the fixed wing portion and to a retracted position wherein the adjustable wing portion is rotated upward and inward toward the fuselage relative to the extended position.

Example embodiment 4 includes the features of example embodiment 2, wherein in the retracted position the adjustable wing portion is rotated 90 degrees or greater relative to the extended position.

Example embodiment 5 includes the features of example embodiment 2, wherein in the retracted position comprises a stowage position wherein the adjustable wing portion is rotated 135 degrees or greater relative to the extended position.

Example embodiment 6 includes the features of example embodiment 1, wherein the drive assembly is positioned at an end of the shaft of the hinge mechanism.

Example embodiment 7 includes the features of example embodiment 1, wherein the drive assembly is substantially coaxial with the shaft of the hinge mechanism.

Example embodiment 8 includes the features of example embodiment 1, wherein the shaft and the drive assembly are contained in a common nacelle.

Example embodiment 9 includes the features of example embodiment 1, comprising: an actuator coupled with the fixed wing portion and configured to selectably actuate a locking mechanism to engage the shaft of the hinge mechanism to lock positioning of the adjustable wing portion relative to the fixed wing portion, and to selectably actuate the locking mechanism to disengage the shaft of the hinge mechanism to permit adjustment of positioning of the adjustable wing portion relative to the fixed wing portion.

Example embodiment 10 includes the features of example embodiment 9, wherein the locking mechanism comprises a locking pin actuatable by the actuator between an extended position wherein the locking pin is received by one of a plurality of sockets of the shaft of the hinge mechanism and a retracted position wherein the locking pin is retracted from the one of the plurality of sockets.

Example embodiment 11 includes the features of example embodiment 10, wherein the plurality of sockets are provided in respective ones of the plurality of shaft flat sections of the shaft.

Example embodiment 12 includes the features of example embodiment 9, wherein the locking mechanism comprises a clutch-brake mechanism.

Example embodiment 13 includes the features of example embodiment 12, wherein the aircraft is configured and operable to fly in a vertical take-off and landing (VTOL) mode and a forward flight mode and to transition in flight from the VTOL mode to the forward flight mode.

Example embodiment 14 includes the features of example embodiment 13, wherein the aircraft is configured and operable to transition in flight from the forward flight mode to the VTOL mode.

Example embodiment 15 includes the features of example embodiment 13, wherein the adjustable wing portion is rotated to a retracted position in the VTOL mode and is rotated to a deployed position in forward flight mode.

Example embodiment 16 includes the features of example embodiment 15, wherein the aircraft includes an electronic control configured to adjust the adjustable wing portion between the retracted position and the deployed position in response to a flight condition of the aircraft without requiring operator selection of the retracted position or the deployed position.

Example embodiment 17 includes the features of example embodiment 16, wherein the electronic control system of the aircraft is configured to adjust the adjustable wing portion between the retracted position and the deployed position in response operator selection of the retracted position, an intermediate position, or the deployed position.

Example embodiment 18 includes the features of example embodiment 1, wherein the fuselage includes a cockpit.

Example embodiment 19 includes the features of example embodiment 1, comprising: a drive assembly including an electric machine operatively coupled with and configured to drive a harmonic drive, the harmonic drive operatively coupled with and configured to rotate a shaft of the hinge mechanism to adjust positioning of at least the portion of the reconfigurable wing relative to the fuselage.

Example embodiment 20 includes the features of example embodiment 19, wherein the harmonic drive is operatively coupled with a spring configured to offset or assist with torsional loading on the harmonic drive.

+While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. An aircraft comprising:
a fuselage; and
a reconfigurable wing including a fixed wing portion fixedly coupled with and extending laterally from the fuselage and an adjustable wing portion extending from and adjustably coupled with the fixed wing portion by a hinge mechanism configured to provide rotation of at least a portion of the adjustable wing portion relative to the fixed wing portion during in-flight operation of the aircraft, the hinge mechanism including a bearing including a first bearing member coupled with the fixed wing portion and a second bearing member rotatably coupled with the first bearing member and fixedly coupled with the shaft at an interface between a plurality of bearing member flat sections of the second bearing member and a plurality of shaft flat sections of the shaft, and a drive assembly including an electric machine operatively coupled with and configured to drive the shaft of the hinge mechanism to adjust positioning of the adjustable wing portion relative to the fuselage.

2. The aircraft of claim 1, wherein the plurality of shaft flat sections are arranged in a polygonal shape and the plurality of bearing member flat sections are arranged in a parallel mating arrangement contacting the plurality of shaft flat sections.

3. The aircraft of claim 1, wherein the adjustable wing portion is adjustable to an extended position wherein the adjustable wing portion is oriented in substantially the same direction as the fixed wing portion and to a retracted position wherein the adjustable wing portion is rotated upward and inward toward the fuselage relative to the extended position.

4. The aircraft of claim 2, wherein in the retracted position the adjustable wing portion is rotated 90 degrees or greater relative to the extended position.

5. The aircraft of claim 2, wherein in the retracted position comprises a stowage position wherein the adjustable wing portion is rotated 135 degrees or greater relative to the extended position.

6. The aircraft of claim 1, wherein the drive assembly is positioned at an end of the shaft of the hinge mechanism.

7. The aircraft of claim 1, wherein the drive assembly is substantially coaxial with the shaft of the hinge mechanism.

8. The aircraft of claim 1, wherein the shaft and the drive assembly are contained in a common nacelle.

9. The aircraft of claim 1, comprising:
an actuator coupled with the fixed wing portion and configured to selectably actuate a locking mechanism to engage the shaft of the hinge mechanism to lock positioning of the adjustable wing portion relative to the fixed wing portion, and to selectably actuate the locking mechanism to disengage the shaft of the hinge mechanism to permit adjustment of positioning of the adjustable wing portion relative to the fixed wing portion.

10. The aircraft of claim 9, wherein the locking mechanism comprises a locking pin actuatable by the actuator between an extended position wherein the locking pin is received by one of a plurality of sockets of the shaft of the hinge mechanism and a retracted position wherein the locking pin is retracted from the one of the plurality of sockets.

11. The aircraft of claim 10, wherein the plurality of sockets are provided in respective ones of the plurality of shaft flat sections of the shaft.

12. The aircraft of claim 9, wherein the locking mechanism comprises a clutch-brake mechanism.

13. The aircraft of claim 12, wherein the aircraft is configured and operable to fly in a vertical take-off and landing (VTOL) mode and a forward flight mode and to transition in flight from the VTOL mode to the forward flight mode.

14. The aircraft of claim 13, wherein the aircraft is configured and operable to transition in flight from the forward flight mode to the VTOL mode.

15. The aircraft of claim 13, wherein the adjustable wing portion is rotated to a retracted position in the VTOL mode and is rotated to a deployed position in forward flight mode.

16. The aircraft of claim 15, wherein the aircraft includes an electronic control configured to adjust the adjustable wing portion between the retracted position and the deployed position in response to a flight condition of the aircraft without requiring operator selection of the retracted position or the deployed position.

17. The aircraft of claim 16, wherein the electronic control system of the aircraft is configured to adjust the adjustable wing portion between the retracted position and the deployed position in response operator selection of the retracted position, an intermediate position, or the deployed position.

18. The aircraft of claim 1, wherein the fuselage includes a cockpit.

19. The aircraft of claim 1, comprising: a drive assembly including an electric machine operatively coupled with and configured to drive a harmonic drive, the harmonic drive operatively coupled with and configured to rotate a shaft of the hinge mechanism to adjust positioning of at least the portion of the reconfigurable wing relative to the fuselage.

20. The aircraft of claim 19, wherein the harmonic drive is operatively coupled with a spring configured to offset or assist with torsional loading on the harmonic drive.
